(19) United States
(12) Patent Application Publication
(10) Pub. No.: US 2013/0037637 A1
(43) Pub. Date: Feb. 14, 2013

(54) DEPOWERED STANDBY PAPER SHREDDER AND METHOD

(71) Applicants: Guanlong Chen, Shanghai (CN); Yung Kang Tso, Shanghai (CN); Kevin Chen, Rancho Palos Verdes, CA (US); Chung Shih Tsai, Hawthorne, CA (US)

(72) Inventors: Guanlong Chen, Shanghai (CN); Yung Kang Tso, Shanghai (CN); Kevin Chen, Rancho Palos Verdes, CA (US); Chung Shih Tsai, Hawthorne, CA (US)

(73) Assignee: Aurora Office Equipment Co., Ltd. Shanghai, Shanghai (CN)

(21) Appl. No.: 13/205,434

(22) Filed: Aug. 8, 2011

(51) Int. Cl. B02C 19/00

(52) U.S. Cl. 241/25; 241/36

(57) ABSTRACT

Apparatus and method for a power-saving shredder, including motorized shredder blades; a shredder controller coupled to the motor controller; a timer coupled to the motor controller, and a mechanically-actuated switch (GREEN SWITCH) couples to the shredder controller. The GREEN SWITCH causes the shredder controller, the motor controller, the motorized shredder blades, and the timer to be activated. The Normally Off switch, when deactuated, causes motorized shredder blades to deactivate. A method of operating a paper shredder includes operating a mechanical actuation switch ON; applying power to paper shredder electrical and electronic elements by operating the mechanical actuation switch; setting a timer for a predetermined active period; operating motorized paper shredder blades by operating the mechanical actuation switch ON; operating the mechanical actuation switch OFF; counting by the timer the predetermined active period; and if the predetermined active period has expired, removing power from the paper shredder electrical and electronic elements.

### BACKGROUND

1. Field of the Invention

The invention is related to paper shredders and in particular, to power-saving paper shredders.

2. Background of the Art

Increasingly, energy-saving configurations of modern electric and electronic devices are becoming more desirable. Typically, an electric device is equipped with an ON/OFF switch corresponding to POWER ON/POWEROFF states respectively. In the POWER ON state, in an operational mode, the main functional parts of a machine become operable during a task. This typically operates the machine with near-maximal power consumption. After the task is complete, the machine shifts to a POWER ON-STANDBY (STANDBY) state, during which at least a portion of the electric circuitry of the machine remains energized, awaiting a cue to resume the operational mode state. Oftentimes, machines remain in the POWER ON/STANDBY state often for many hours per week as a convenience to the user. This convenience bears the cost of a constant, if lower level, of energy consumption. Masses of these products, in the aggregate, wastefully consume substantial amounts of energy, creating a background level of non-purposeful energy consumption. Paper shredders typically have ON/OFF/STANDBY states and remain at least partially energized while in STANDBY state. A powerless standby mode is useful.

### SUMMARY OF THE INVENTION

Embodiments provide apparatus and method for a power-saving shredder that comminutes shreddant, including motorized shredder blades to comminute shreddant when activated; a motor controller coupled to the motorized shredder blades; a shredder controller coupled to the motor controller; a timer coupled to the motor controller, wherein the timer is activated over a predetermined active period; and a mechanically-actuated switch (GREEN SWITCH) coupled to the shredder controller.

The GREEN SWITCH while actuated causes the shredder controller, the motor controller, the motorized shredder blades, and the timer to be activated. The GREEN SWITCH causes the motorized shredder blades to become deactivated when deactuated. The GREEN SWITCH is a Normally Off switch. The timer causes power to be removed from the shredder controller, the motor controller, and the motorized shredder blades upon expiration of the predetermined active period.

Certain embodiments have a predetermined active period being less than about one hour. In other embodiments, the predetermined active period is less than about five minutes. In yet other embodiments, wherein the mechanically-actuated switch comprises a single pole, single throw switch. In still other embodiments, the mechanically-actuated switch is a mechanically-actuated switch trip switch and, in some cases, the mechanically-actuated switch is a single pole, single throw, trip switch and wherein the predetermined active period comprises less than about one hour. In some embodiments, the mechanically-actuated switch is disposed in a paper feed inlet opening throat.

In still another embodiment, a shredder for comminuting shreddant, includes motorized shredder blades to comminute shreddant when activated; a motor controller coupled to the motorized shredder blades; a shredder controller coupled to the motor controller, including a timer coupled therein, wherein the timer is activated over a predetermined active period; a power enable/disable (PED) switch to provide electric power to the motorized shredder blades, the motor controller, and the shredder controller with a timer when in the power enabled state; and a mechanically-actuated switch (GREEN SWITCH) coupled to the shredder controller.

The GREEN SWITCH while actuated causes the shredder controller, the motor controller, the motorized shredder blades, and the timer to be activated. The GREEN SWITCH causes the motorized shredder blades to become deactivated when deactuated. The GREEN SWITCH is a Normally Off switch. Typically, the timer causes power to be removed from the shredder controller, the motor controller, and the motorized shredder blades upon expiration of the predetermined active period.

In embodiments, the shredder with the mechanically-actuated switch includes a single pole, single throw, trip switch and the predetermined active period comprises less than about one hour. In other embodiments, the mechanically-actuated switch comprises a single pole, single throw switch and the predetermined active period comprises about five minutes.

An example method of operating a paper shredder is provided, including operating a mechanical actuation switch ON; applying power to paper shredder electrical and electronic elements by operating the mechanical actuation switch; setting a timer for a predetermined active period; operating motorized paper shredder blades by operating the mechanical actuation switch ON; operating the mechanical actuation switch OFF; counting by the timer the predetermined active period; and if the predetermined active period has expired, removing power from the paper shredder electrical and electronic elements. In some of these embodiments, operating a mechanical actuation switch ON further comprises operating a mechanical actuation switch ON in the paper shredder feed inlet throat. In other embodiments, before operating the mechanical actuation switch ON, enabling power to the paper shredder using a power enable/disable switch. The method also can include after the operating the mechanical actuation switch ON, sensing a shreddant in the paper feed inlet. In particular matters, electro-optically sensing a shreddant in the paper feed inlet may be performed.

Described herein are example embodiments of a paper shredder having a depowered standby state.

### BRIEF DESCRIPTION OF THE FIGURES

Embodiment of the present invention disclosed herein are illustrated by way of example, and are not limited by the accompanying figures, in which like references indicate similar elements, and in which:

FIG. 1 is an embodiment of a depowered standby paper shredder, in accordance with the teachings of the present invention;

FIG. 2 is another embodiment of a depowered standby paper shredder, in accordance with the teachings of the present invention;

FIG. 3 is a schematic diagram of a shredder control system for depowered standby paper shredder, in accordance with the teachings of the present invention; and

FIG. 4 is a flow diagram for a method of operating a depowered standby paper shredder, in accordance with the teachings of the present invention.

Skilled artisans can appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION OF THE EMBODIMENTS

Embodiments disclosed herein disclose a paper shredder that has ON/OFF/STANDBY states and a POWERLESS STANDBY (GREEN) state as well. When powered ON, the shredder can enter a POWERED STANDBY state for a predetermined active period, prepared for imminent shredder functioning. After a predetermined period without operation, the shredder is directed to the GREEN state, upon expiration of the active period. In the GREEN state, all power to shredder motor and control electronics is removed and the shredded is powered down. However, the shredder can be made to operate (i.e., “be awakened”), simply by placing shreddant in the paper feed inlet and actuating the mechanical actuation switch. Thus, no power is required in the depowered standby state.

A mechanically-actuated trip switch (GREEN SWITCH) may be used as a mechanical wake-up switch to power up the shredder, and to allow POWER ON functioning for a limited, predetermined active period. The GREEN SWITCH may be a single pole, single throw, normally open (OFF) switch, including one of a trip switch, a micro-switch, or any type of mechanical switch sensitive enough to detect the presence of a shreddant. For convenient use, the GREEN SWITCH may be disposed at the feed inlet opening or in the throat of the shredder to prevent accidental actuation. In contrast to an electro-optical switch, the GREEN SWITCH of the present embodiments consumes no power itself, and does not require sentinel or monitor electronics to be powered up to sense paper feed and to power the shredder circuitry. An electro-optical switch may be used to sense the presence of shreddant in the shredder feed throat during the active period but it, too, can be powered down after the active period has expired. The GREEN SWITCH then can be used to restore power for shredding when shreddant is present at the (normally open) GREEN SWITCH. Alternatively, the GREEN SWITCH may be used in place of the electro-optical switch, or other shredder operation sensor, so that the shredder has few parts, less complexity, and greater economy.

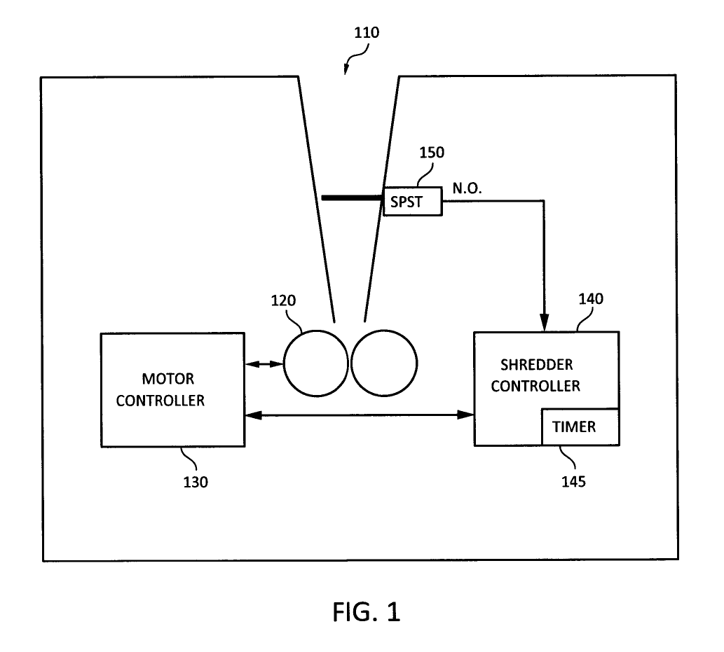

FIG. 1 is an example embodiment of shredder 100 using GREEN SWITCH 150 to admit power to the shredder controller 140, motor controller 130, and motorized shredder blades 120. Shredder 100 includes a feed opening inlet, with a throat, generally at 110, motorized shredder blades 120, motor controller 130, and shredder controller 140. Controller 140 can include a timer 145, which can be used to control a predetermined active period. The predetermined active period can be controlled to limit the amount of time controllers 130, 140 are empowered with electricity. Upon expiration of the predetermined active period, for example up, less than one hour, power is disconnected from the controllers 130, 140 and the motorized shredder blades 120. Unlike shredder 200, shredder 100 does not include a PED switch, such as PED switch 270. Also, shredder 100 may not include an electro-optic sensor, such as electro-optic device 260.

Instead, application of power to shredder 100 can be initiated by actuation of the GREEN SWITCH 150 located in throat 110, and can be deactivated upon expiration of the predetermined active period as sensed by timer 145. Shredder blades 120 can be activated during mechanical operation (e.g., deflection) of GREEN SWITCH 150. After GREEN SWITCH 150 returns to its base state (e.g., undeflected), shredder 100 may enter a powered STANDBY state for the duration of the predetermined active period. Timer 145 is configured to signal shredder controller 140 to remove power from shredder 100, including motorized shredder blades 120, motor controller 130, and shredder controller 140. Of course, neither shredder 100 nor shredder 200 is required to have discrete controllers 130, 140, or 230, 240, respectively, but one or both may have an integrated controller. Even so, controller 140 is operatively coupled to controller 130 and through controller 130, to motorized shredder blades 120.

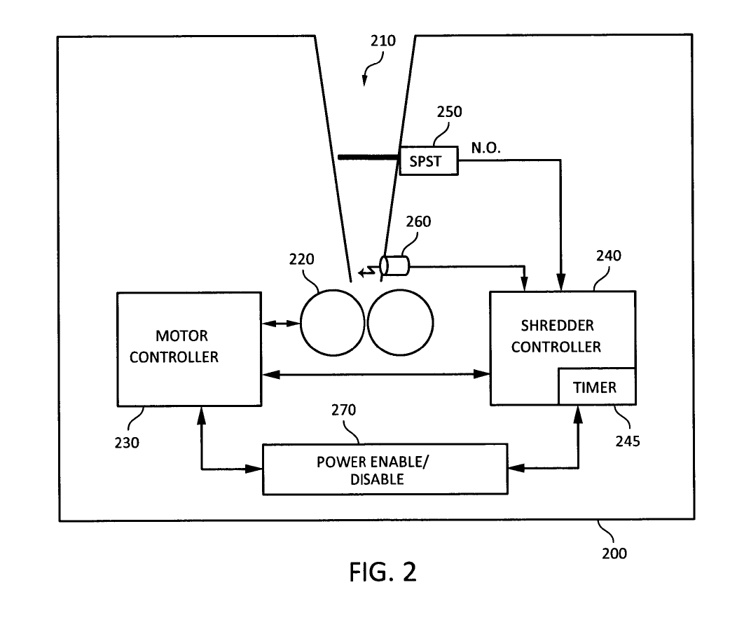

Turning to FIG. 2, example embodiment shredder 200 can include a feed throat generally at 210, motorized shredder blades 220, motor controller 230 to provide electrical power to the shredder motor, shredder controller 240 operatively coupled to motor controller 230, mechanically-operated switch 250 operatively coupled to shredder controller 240 and, in some embodiments, electro-optical sensor 260 also operatively coupled to shredder controller 240. Power is enabled or disabled by power enable/disable (PED) switch 270. PED switch 270 allows power to be available or unavailable to the controllers 230, 240 in accordance with the operation of GREEN SWITCH 250. A timer 245 is provided to turn power off to motorized shredder blades 220, motor controller 230 and shredder controller 240 after a predetermined active period, for example, a predetermined active period of 5 minutes. Other predetermined active periods are contemplated.

Once power is turned off to controllers 230, 240, power can be restored to controllers 230, 240 and motor 220 after operation of GREEN SWITCH 250. Such a configuration can reduce the amount of standby power used by shredder 200 during long period of non-use. By contrast, existing shredders would remain at least partly powered up, for example, at least part of the shredder controller of an existing shredder would consume energy, for hours or longer, until the shredder power switch was turned off. PED switch 270 allows or prevents power to flow to the controllers 230, 240 and motors 220. However, no power is provided to these elements until activated by the GREEN SWITCH 250 or during a predetermined active period.

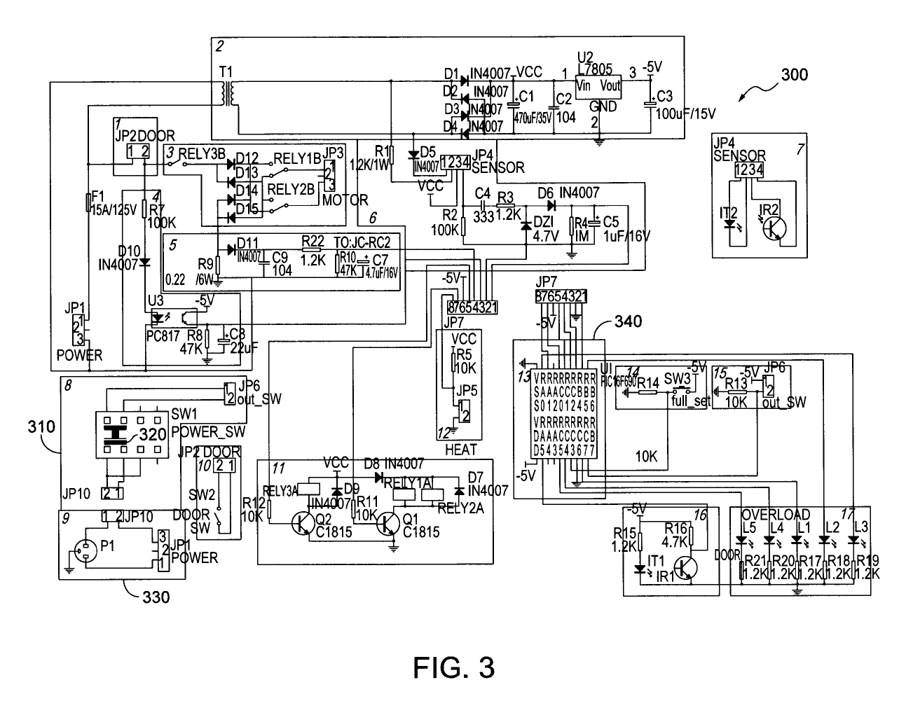

FIG. 3 depicts an example schematic diagram for a shredder 300, in accordance with the teachings herein. Assembly block 8 includes switch assembly 310 having a mechanically-actuated switch 320. Assembly block 9 includes power module 330. When switch 320 is actuated, an electrical path is completed through power module 330, and the electromechanical elements of shredder 300 are electrically energized. When switch 320 is deactuated, microcontroller 340 can count elapsed time for the predetermined active period to maintain powered standby, then change states into the depowered standby state. Microcontroller 340 in assembly block 13 can control, at least in part, the shredder controller and the shredder motor controller. Microcontroller 340 can be a PIC16F690 20-Pin Flash-Based, 8-Bit CMOS Microcontroller, produced by Microchip Technology Inc., Chandler, Ariz., USA. Microcontroller 340 can provide timing, command, and control functions of shredder 300. Indeed, microcontroller 340 can include a timer used to measure the predetermined active period.

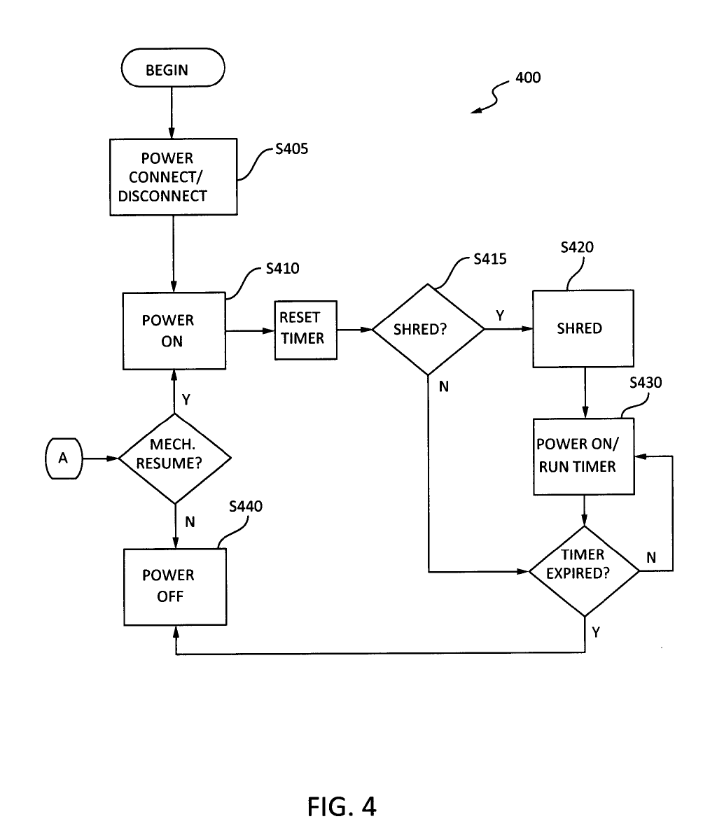

Turning to FIG. 4, an example method of operating a shredder with a GREEN switch (400) is given, in accordance with the present embodiments. Method 400 may begin by allowing electrical power to be available to a shredder by connecting (S405) the shredder to the electrical main, for example, by a PEDS switch. Alternatively, connecting (S405) the shredder to the electrical main can be performed directly by a mechanically-actuated trip switch (GREEN SWITCH). Initially powering on (S410) shredder and motor controllers, the shredder begins a powered standby state for a limited, predetermined active period awaiting introduction of shreddant (S415) into the feed inlet opening. If shreddant is introduced, method 400 may proceed by powering up the shredder motor and shredding (S420) the introduced shreddant. Otherwise, a timer begins a counting a timer (S430) towards the expiration of a predetermined period.

If no shreddant is introduced while the shredder is powered up and during the predetermined active period, powering off (S440) all electrical (e.g., motorized shredder blades) and electronic (e.g., controllers), for example, by a timer limit signal, reduces power consumption of the shredder to zero. However, an act of inserting shreddant (S450) is a command by the user via the GREEN SWITCH to resuming shredder operation (S455), in which case, the shredder begins operating by powering on (S410) the electrical and electronic components as before. Otherwise, the shredder electricity remains off.

The embodiments of the present invention disclosed herein are intended to be illustrative only, and are not intended to limit the scope of the invention. It should be understood by those skilled in the art that various modifications and adaptations of the prevent invention as well as alternative embodiments of the prevent invention may be contemplated or foreseeable. It is to be understood that the present invention is not limited to the sole embodiments described above, but encompasses any and all embodiments within the scope of the following claims.

What is claimed is:

1. A shredder for comminuting shreddant, comprising:
motorized shredder blades to comminute shreddant when activated;
a motor controller coupled to the motorized shredder blades;
a shredder controller coupled to the motor controller;
a timer coupled to the motor controller, wherein the timer is activated over a predetermined active period; and
a mechanically-actuated switch (GREEN SWITCH) coupled to the shredder controller,
wherein the GREEN SWITCH while actuated causes the shredder controller, the motor controller, the motorized shredder blades, and the timer to be activated,
wherein the GREEN SWITCH causes the motorized shredder blades to become deactivated when deactuated,
wherein the GREEN SWITCH is a Normally Off switch, and
wherein the timer causes power to be removed from the shredder controller, the motor controller, and the motorized shredder blades upon expiration of the predetermined active period.

2. The shredder of claim 1, wherein the predetermined active period comprises less than about one hour.

3. The shredder of claim 1, wherein the predetermined active period comprises less than about five minutes.

4. The shredder of claim 1, wherein the mechanically-actuated switch comprises a single pole, single throw switch.

5. The shredder of claim 1, wherein the mechanically-actuated switch comprises a mechanically-actuated switch trip switch.

6. The shredder of claim 2, wherein the mechanically-actuated switch comprises a single pole, single throw, trip switch and wherein the predetermined active period comprises less than about one hour.

7. The shredder of claim 1, wherein the mechanically-actuated switch is disposed in a paper feed inlet opening throat.

8. A shredder for comminuting shreddant, comprising:
motorized shredder blades to comminute shreddant when activated;
a motor controller coupled to the motorized shredder blades;
a shredder controller coupled to the motor controller, including a timer coupled therein, wherein the timer is activated over a predetermined active period;
a power enable/disable (PED) switch to provide electric power to the motorized shredder blades, the motor controller, and the shredder controller with a timer when in the power enabled state; and
a mechanically-actuated switch (GREEN SWITCH) coupled to the shredder controller,
wherein the GREEN SWITCH while actuated causes the shredder controller, the motor controller, the motorized shredder blades, and the timer to be activated,
wherein the GREEN SWITCH causes the motorized shredder blades to become deactivated when deactuated,
wherein the GREEN SWITCH is a Normally Off switch, and
wherein the timer causes power to be removed from the shredder controller, the motor controller, and the motorized shredder blades upon expiration of the predetermined active period.

9. The shredder of claim 8, wherein the mechanically-actuated switch comprises a single pole, single throw, trip switch and wherein the predetermined active period comprises less than about one hour.

10. The shredder of claim 8, wherein the mechanically-actuated switch comprises a single pole, single throw switch and wherein the predetermined active period comprises about five minutes.

11. A method of operating a paper shredder, comprising:
operating a mechanical actuation switch ON;
applying power to paper shredder electrical and electronic elements by operating the mechanical actuation switch;
setting a timer for a predetermined active period;
operating motorized paper shredder blades by operating the mechanical actuation switch ON;
operating the mechanical actuation switch OFF;
counting by the timer the predetermined active period; and
if the predetermined active period has expired, removing power from the paper shredder electrical and electronic elements.

12. The method of claim 11, wherein operating a mechanical actuation switch ON further comprises operating a mechanical actuation switch ON in the paper shredder feed inlet throat.

13. The method of claim 11, further comprising before operating the mechanical actuation switch ON, enabling power to the paper shredder using a power enable/disable switch.

14. The method of claim 11, further comprising:
after the operating the mechanical actuation switch ON, sensing a shreddant in the paper feed inlet.

15. The method of claim 14, further comprising electro-optically sensing a shreddant in the paper feed inlet.
